(19) United States
(12) Patent Application Publication
(10) Pub. No.: US 2008/0296199 A1
(43) Pub. Date: Dec. 4, 2008

(54) Kit and Method for Use in Connection with Ordering Plaques and Similar Items that Preserve Documents and the Like

(75) Inventors: Teddy Struhl, Boca Raton, FL (US); Avi Moskowitz, Efrat (IL); Warren Struhl, Boca Raton, FL (US)

Correspondence Address: FISH & RICHARDSON P.C., P.O. BOX 1022, MINNEAPOLIS, MN, 55440-1022, US

(73) Assignee: LAMINATED SUCCESS, LLC, Teaneck, NJ (US)

(21) Appl. No.: 11/757,035

(22) Filed: Jun. 1, 2007

(51) Int. Cl. G06Q 30/00

(52) U.S. Cl. 206/575; 705/26

(57) ABSTRACT

A kit and method are provided for use in connection with ordering plaques and similar achievement recognition items that preserve documents. Depending on the implementation, a user purchases a kit that guides the user through the process of customizing and ordering a plaque or similar item. In some implementations, the user submits (e.g., via mail or electronically) a tangible or electronic document for incorporation into the plaque or similar item.

### TECHNICAL FIELD

This disclosure relates to a kit and method for use in connection with ordering plaques and similar items that preserve documents and the like.

### BACKGROUND

Many individuals, businesses, and groups have awards, diplomas, certificates, articles, photographs and other documents highlighting their achievements and accomplishments that they may want to be preserved or displayed. However, there are challenges associated with acquiring laminated plaques and other achievement recognition items. These challenges include the fact that: (1) there are few retail outlets for purchasing such items; (2) such retail outlets that do sell these items may not have knowledgeable staff; (3) the ordering process may be complex, along with complicated and often inflated pricing models; (4) long turnaround time; and (5) the appearance and quality of the end product is often unpredictable and any customization (e.g., text) is prone to errors.

### SUMMARY

In an aspect of the present invention, a kit and method are provided for use in connection with ordering plaques and similar items that preserve documents. Depending on the implementation, a user purchases a kit that guides the user through the process of customizing and ordering a plaque, desktop marquee, commemorative item, or the like (hereinafter “plaque”). In some implementations, the user submits (e.g., via mail or electronically) a tangible or electronic document, graphic, or item (hereinafter “document”) for incorporation into the plaque or similar item.

The details of one or more implementations are set forth in the accompanying drawings and the description below. Various features and advantages will be apparent from the following description and drawings, and from the claims.

### BRIEF DESCRIPTION OF DRAWINGS

FIG. 1 is an illustration of an implementation of a kit.

FIG. 2A is an illustration of an exemplary method for proceeding with an order for a plaque (or other achievement recognition item) by completing an order form.

FIG. 2B is an illustration of an exemplary order form.

FIG. 3 is an illustration of an exemplary method for proceeding with an order for a plaque (or similar item) by utilizing a website.

FIGS. 4A-4F are examples of screenshots of a website for ordering a plaque (or other achievement recognition item).

### DETAILED DESCRIPTION

The following is a description of various implementations of a kit and method for use in connection with ordering plaques or other achievement recognition items that preserve documents.

Implementations of a Kit

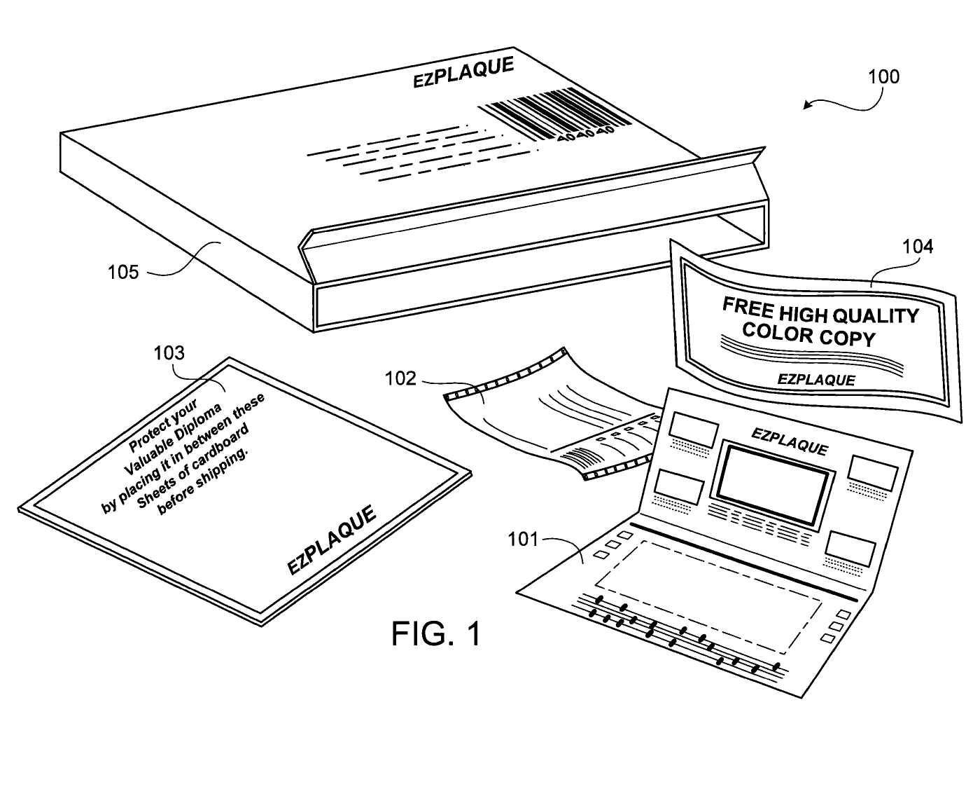

FIG. 1 illustrates an implementation of a kit 100 that guides a user through the process of ordering a customized plaque or similar achievement recognition item. Depending on the implementation, the user submits (e.g., via mail or electronically) a tangible or electronic document to a fulfillment agent for incorporation into a plaque or similar item. The fulfillment agent receives the document from the user, and expedites creation of the plaque based on the user's preferences regarding appearance and content. After the plaque is completed, the fulfillment agent ships or otherwise provides the plaque to the user. The fulfillment agent may itself manufacture the plaque, or it may be an agent of one or more manufacturers.

In the case where a user submits a tangible document (e.g., a diploma), the document is returned to the user in the preserved form of a laminated plaque, framed piece or via another sealant process (e.g., acrylic, glass, aluminum, metal with a glass cover as an encasement). In the case of an electronic document, the document is reproduced in a manner chosen by the user (e.g., color or black and white, size, paper type) and is returned to the user preserved in a tangible form. Documents that may be submitted include (but are not limited to) certificates, diplomas, professional licenses, photographs, artwork, letters and other items and may be composed of any material including, but not limited to, paper, cloth, parchment, sheepskin, newsprint or photographs.

The kit 100 comes in a package 105 that, preferably, includes an SKU (stock keeping unit). A benefit of placing an SKU on the package 105, aside from inventory control, is that it can simplify the process for procuring plaques or other achievement recognition items. Whereas in a conventional process a user would have to find and travel to a trophy shop or the like to purchase a plaque, the kit 100 can be sold at any retail location. Accordingly, the kit 100 can be made widely available, making the purchase of plaques more convenient. In fact, in some implementations, the user may purchase the kit 100 on-line.

While the content of the kit 100 can vary depending on the implementation, in some implementations, the kit 100 includes a protective mailer 103. The protective mailer 103 is provided so that the user can safely mail a document (that it wants included in a plaque) to the fulfillment agent. Often, users seek to preserve important documents such as certificates and diplomas, so it is generally desirable to take measures to preserve the condition of the document(s) provided by the user. The protective mailer 103 can be rectangular (as shown), cylindrical, or some other suitable shape. Implementations that are customized for larger or smaller documents can include appropriately sized mailers.

If the original document is a tangible (e.g., paper) document, the user will be without the original copy of the document after it is mailed. Thus, some implementations include a certificate 104 for a free copy of the original document. The certificate may be for a color copy, and may be branded to encourage the user to visit a particular copy services vendor.

To mail the original document, a mailing label 102 is included. The mailing label, in some implementations, is prepaid. If the label 102 is prepaid, the cost of the kit 100 may include the cost of the shipping. For mailing, the mailing label 102 is placed on the protective mailer 103. For additional protection, the protective mailer 103 may be placed in an envelope or the like, in which case the mailing label 102 is placed on the envelope. In some implementations, the mailing label 102 allows the user to track the shipment of the document.

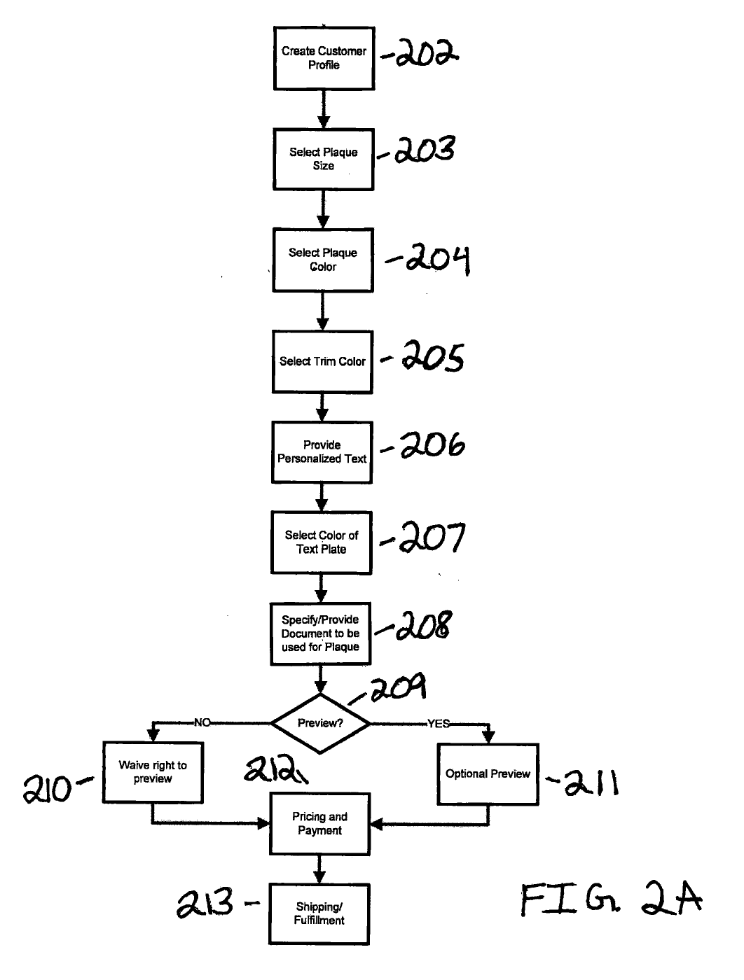

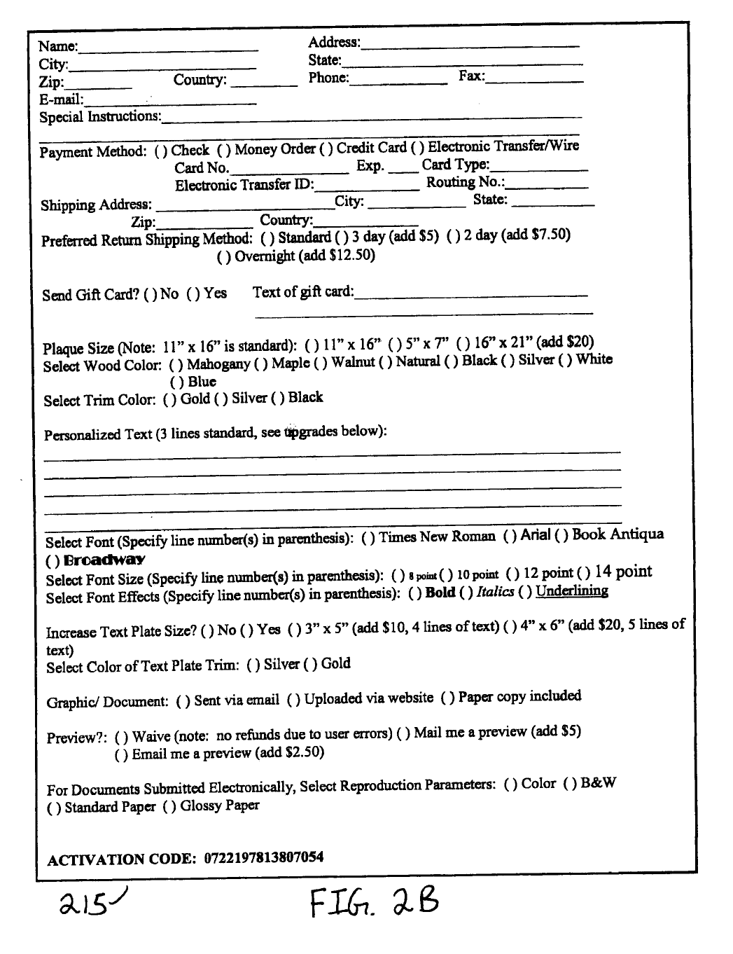

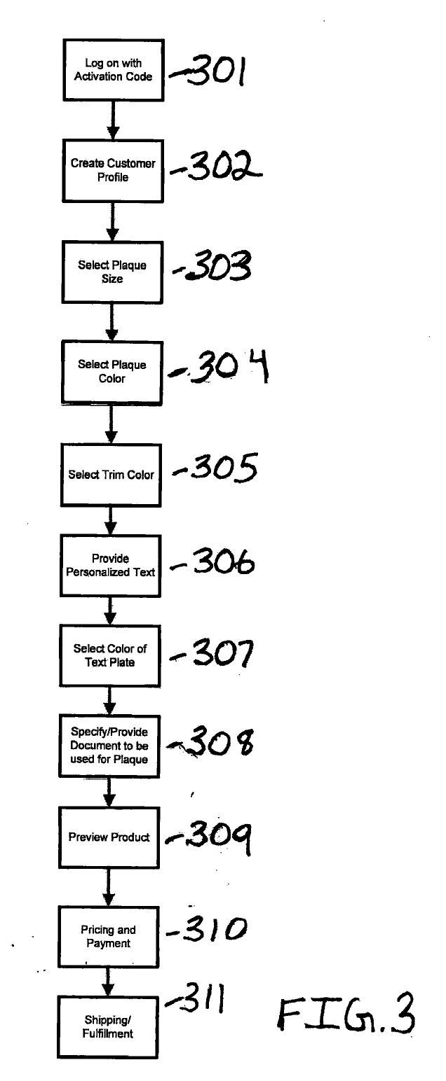

An order form 101 is provided to allow the user to customize the plaque or similar item. Also, the order form 101 can include an activation code which allows the user to customize the plaque via a web interface. In some implementations, the kit 101 gives the user the option of proceeding either via the order form 101 or via a web interface (see FIGS. 2A and 3). The order form 101 may, in some implementations, include secure codes and/or order numbers that allow users to preview, modify and/or monitor the status of their order at any point in time. As a result, orders can be tracked and are traceable with status updates from a web application and/or emails. Allowing a user to preview, modify and/or monitor the status of an order can minimize the potential for errors and make plaque (and other achievement recognition items) procurement faster and more efficient. An implementation of an order form is illustrated in FIG. 2B in more detail.

Moreover, some kits may include swatches of materials used in the plaque production process to give users a preview of how the finished plaque may appear.

Kits may be provided for special purposes. For example, the kit 100 may be customized for (1) celebrating the birth of a child; (2) holiday kits to celebrate religious holidays and other religious milestones and occasions; (3) weddings, engagements, or anniversaries; (4) employee-of-the-month; (5) memorials and (6) new-business launches. Such kits may includes specialized clip art, pre-designed formats and templates, specialty papers, appliqués, layouts and customized software associated for the web interface.

Implementations of Paper-Based Method

After purchase of a kit (e.g., item 100 of FIG. 1), a user may proceed with the order and customization of a plaque either via a web interface or by completing the order form (e.g., item 101 of FIG. 1 or item 215 of FIG. 2B) and submitting it (e.g., via mail or fax) to a fulfillment agent.

FIG. 2A illustrates an example of a method for proceeding with an order for a plaque (or similar item) by completing an order form (e.g., item 101 of FIG. 1 or item 215 of FIG. 2B). After a user purchases a kit (e.g., item 100 of FIG. 1), he completes an order form. In one portion of the order form, the user creates a customer profile (202). The customer profile can include information such as: name, address, phone number, email address, fax number and any special instructions. The special instructions may relate, for example, to gift orders. A user may order a plaque for another person, and may want to include a certain gift note or the like along with the plaque. The customer profile also may include shipping information (if it differs from a billing address).

In another portion of the order form, the user selects a plaque size (203). Although it varies depending on the kit, the default plaque size indicated on the illustrated order form is 11″×16″. The user is given options, however, to select a different size. Different sizes may have different costs. Those different costs may be indicated on the order form, or the fulfillment agent may contact the user after receipt of the order form to provide pricing information.

In another portion of the order form, the user selects the color of plaque (204). Color options can vary, but examples include mahogany, maple, walnut, natural, black, silver or blue. The user also may be provided with different grades of material, each having an associated cost.

In yet another portion of the order form, the user selects the trim color of the plaque (205). Depending on the implementation, trim color options include gold, silver or black.

The order form also allows the user to specify personalized text. If the user desires personalized text, he specifies the exact text desired (206). Depending on the implementation, up to five lines of text can be specified. Users may choose the font, the size and other text attributes (e.g., bold or italics). In some implementations, the personalized text on the plaque is provided on a text plate (e.g., a metal plate that can be engraved). Users may choose a text plate trim color (207) such as gold or silver, and may specify a larger text plate size (e.g., at an additional cost).

To customize the plaque, the user provides a document to be incorporated into the plaque (208). The document may be, e.g., a diploma, a certificate, a magazine article, a photo, or the like. The document may be provided to the fulfillment agent in a variety of ways. The user may mail the document (e.g., in protective mailer 103 of FIG. 1) along with the order form to the fulfillment agent. If the user decides to mail the document, the user can mail, for example, a paper document or a storage medium (e.g., a CD-ROM or a flash drive) that contains an electronic version of the document to the fulfillment agent. Alternatively, the user can upload (e.g., via a web application) or email the document to the fulfillment agent. Preferably, when a user uploads or emails a document, the activation code on the order form is used to associate the electronic document with the order.

The order form also may give the user an option of a preview (209). The user may choose to waive its right to a preview (210), but, in some implementations, the order form warns the user that orders are not refundable due to user errors. Alternatively, the user may choose to be furnished with a preview (211). The preview may involve an additional charge, and can be provided electronically (e.g., via email) or on paper (e.g., via mail or fax). The web application (discussed below in connection with FIG. 3) provides nearly instantaneous previews, which may encourage some users to utilize the web application rather than the paper-based method. Users who do not have access to the web or who are not accustomed to using computers may prefer to use the paper order form.

The order form provides the user with pricing information for the order, and allows the user to specify the manner of payment (212). In some implementations, credit card payment is utilized, but other options are possible such as checks or electronic transfers. Also, the order form indicates where optional charges are involved for selected options or quantities not included with the original kit cost.

In some implementations, the activation code allows the fulfillment center to track the amount paid for each kit, and thereby determine and confirm the optional charges. In many implementations, the cost of the kit is the only fee paid for the plaque (or similar achievement recognition item), unless the user's customization implicates optional charges. In some implementations, differently priced kits are available which reflect different levels of default options (e.g., plaque size, materials, glare treatment, etc.). For example, an entry level kit may be for a 6″×8″ plaque with two lines of text whereas a premium kit may be for an 18″×24″ plaque with gold accents, anti-glare treatment, and seven lines of text. The activation codes that are included with the entry level kit and the premium kit should be unique, and identify these default options. Moreover, the order forms in these kits are customized to reflect the appropriate default options and upgrade pricing.

Once the fulfillment agent receives the order form, it is responsible for shipping and fulfillment (e.g., manufacture) (213) of the plaque or other achievement recognition item. Depending upon the implementation, the standard shipping time is about two weeks from the date of submission of the order. As the goods are customized, some implementations do not allow a user to cancel the order once it has been sent for production. The fulfillment agent, depending on the implementation, provides an email or hardcopy confirmation of the specifications and pricing of the order once it is received by the production department. The finished product (e.g., a plaque) may include a guarantee on the workmanship and materials.

FIG. 2B is an illustration of implementation of a order form 215 useable with the foregoing method. This order form is for an 11″×16″ plaque with five lines of text. Possible upgrades include: (1) increasing the plaque size, (2) increasing the text plate size and (3) previews.

Implementations of a Web-Based Method

FIG. 3 illustrates an example of a method for proceeding with an order for a plaque (or similar item) by utilizing a web-based application. After a user purchases a kit (e.g., item 100 of FIG. 1), he logs on to a website that is identified in the kit. The user gains access by logging in to the website using the activation code (301). Once logged in, the user creates a customer profile (302). The customer profile can include information such as: name, address, phone number, email address, fax number and any special instructions. The special instructions may relate, for example, to gift orders. A user may order a plaque for another person, and may want to include a certain gift note or the like along with the plaque. The gift note may be emailed to the recipient, along with an image of the completed design. The customer profile also may include shipping information (if it differs from a billing address).

Next, the user selects a plaque size (303). Although it varies depending on the kit and the activation code, the default plaque size is 11″×16″. The user is given options, however, to select a different size. Different sizes may have different costs. Those different costs may be indicated on the website, or the fulfillment agent may contact the user (e.g., via email) after receipt of the order form to provide pricing information.

Next, the user selects the color of plaque (304). Color options can vary, but examples include mahogany, maple, walnut, natural, black, silver or blue. The user also may be provided with different grades of material, each having an associated cost.

The website then allows the user to select the trim color of the plaque (305). Examples of trim color options include gold, silver or black.

The website also allows the user to specify personalized text. If the user desires personalized text, he specifies the exact text desired (306). Depending on the implementation, up to five lines of text can be specified. Users may choose the font, the size and other text attributes (e.g., bold or italics). In some implementations, the personalized text on the plaque is provided on a text plate (e.g., a metal plate that can be engraved). Users may choose a text plate trim color (307) such as gold or silver, and may specify a larger text plate size (at an additional cost).

To customize the plaque, the user may provide a document to be incorporated into the plaque (308). The document may be, e.g., a diploma, a certificate, a magazine article, a photo, or the like. The document may be provided to the fulfillment agent in a variety of ways. The user may mail the document (e.g., in protective mailer 103 of FIG. 1), along with the order form, to the fulfillment agent. The activation code on the order form is used, in some implementations, to associate the mailed document with the order. If the user decides to mail the document, the user can mail, for example, a paper document or a storage medium (e.g., a CD-ROM or a flash drive) containing an electronic version of the document to the fulfillment agent. Alternatively, the user can upload (e.g., via the web application) or email the document to the fulfillment agent. In some implementations, when a user uploads or emails a document, he provides the activation code on the order form, which is used to associate the electronic document with the order.

The user is provided with a preview (309). In some implementations, the preview is created as the user customizes the plaque, or soon thereafter. Thus, the user can experiment with several previews by varying color, text, etc. until the user is satisfied. Once the user approves the preview, a web application creates a work order for the manufacture, billing and shipment of the achievement recognition item. In some implementations, the work order is not submitted for manufacturing until payment (if required) is finalized.

The website provides the user with pricing information for the order, and allows the user to specify the manner of payment (310), if needed. In some implementations, the activation code allows the fulfillment agent to track the amount paid for each kit, and thereby determine and confirm the optional charges. In some implementations, the cost of the kit is the only fee paid for the plaque, unless there are optional charges incurred due to choices made in the customization process. Credit card payment may be utilized, but other options are possible such as checks or electronic transfers. A user may not be required to supply credit card information if no optional charges are incurred.

Once the fulfillment agent receives the order, it is responsible for shipping and fulfillment (e.g., manufacture) of the plaque or other achievement recognition item. (311). Depending upon the implementation, the standard shipping time is about two weeks from the date of submission of the order. As the goods are customized, some implementations do not allow a user to cancel the order once it has been sent for production. Moreover, some implementations prompt the user to confirm his understanding that no additional proofs will be provided once the order has been sent for production. The fulfillment agent, depending on the implementation, provides an email or hardcopy confirmation of the specifications and pricing of the order once it is received by the production department. The plaque may be protected by a guarantee on the workmanship and materials.

The web application may be executed, for example, on a personal computer, or may be implemented on a self-serve kiosk (e.g., in a retail environment). Kiosks can facilitate document submission (e.g., mailing, email, fax), ordering and payment.

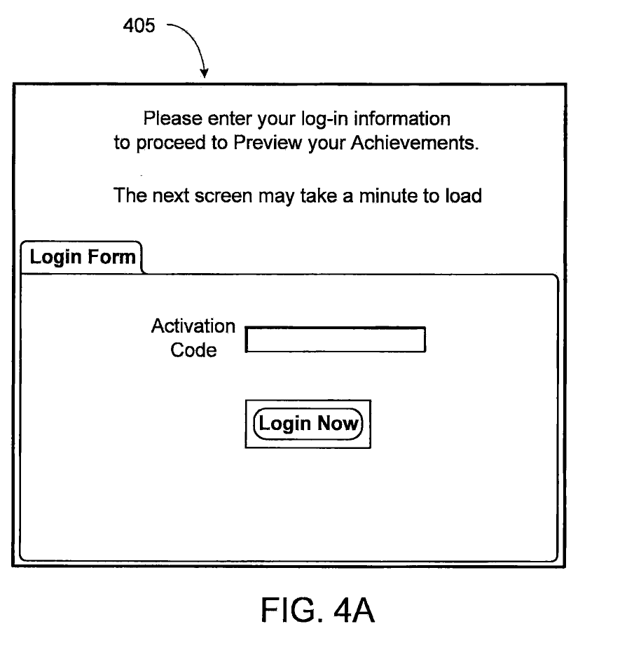

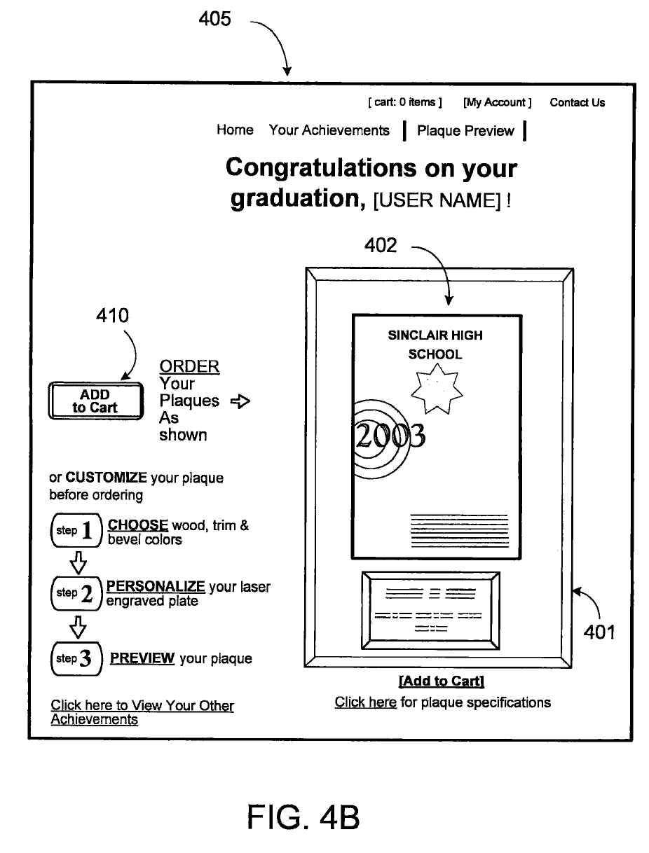

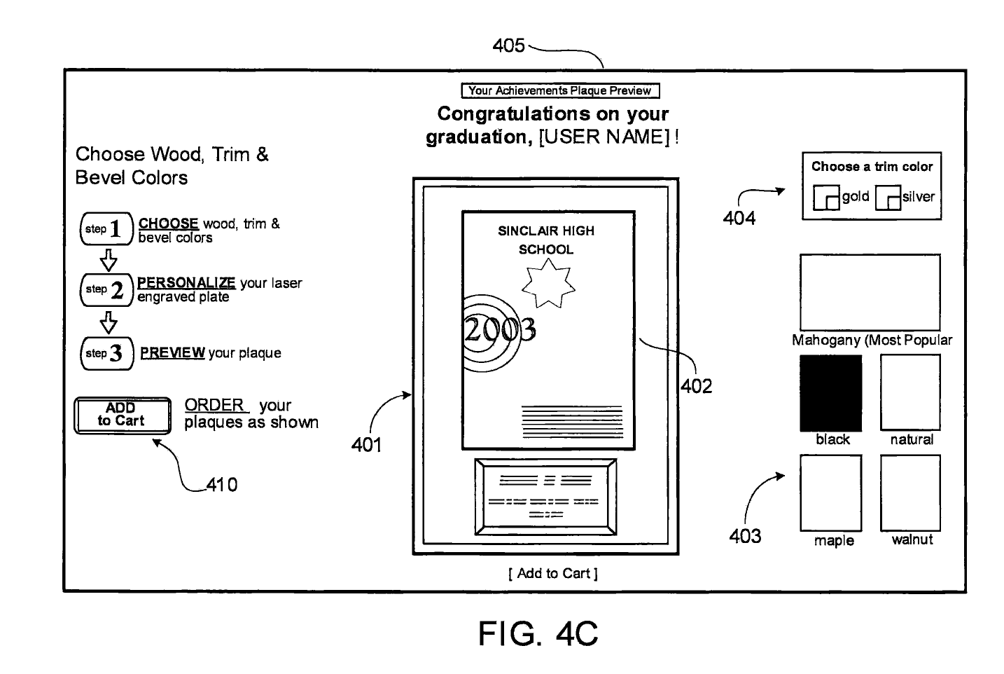

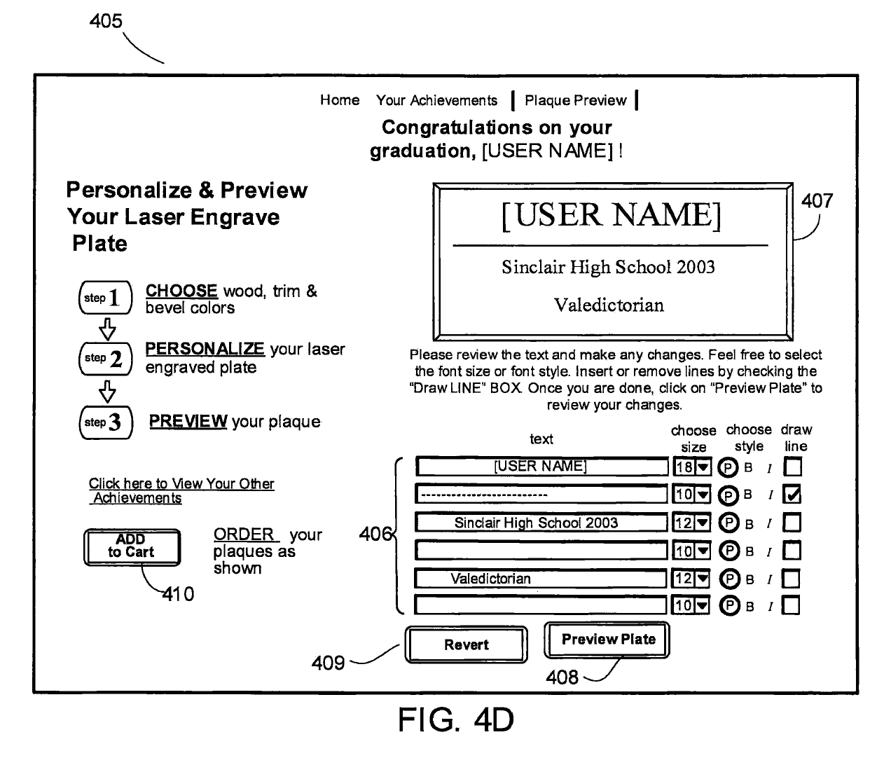

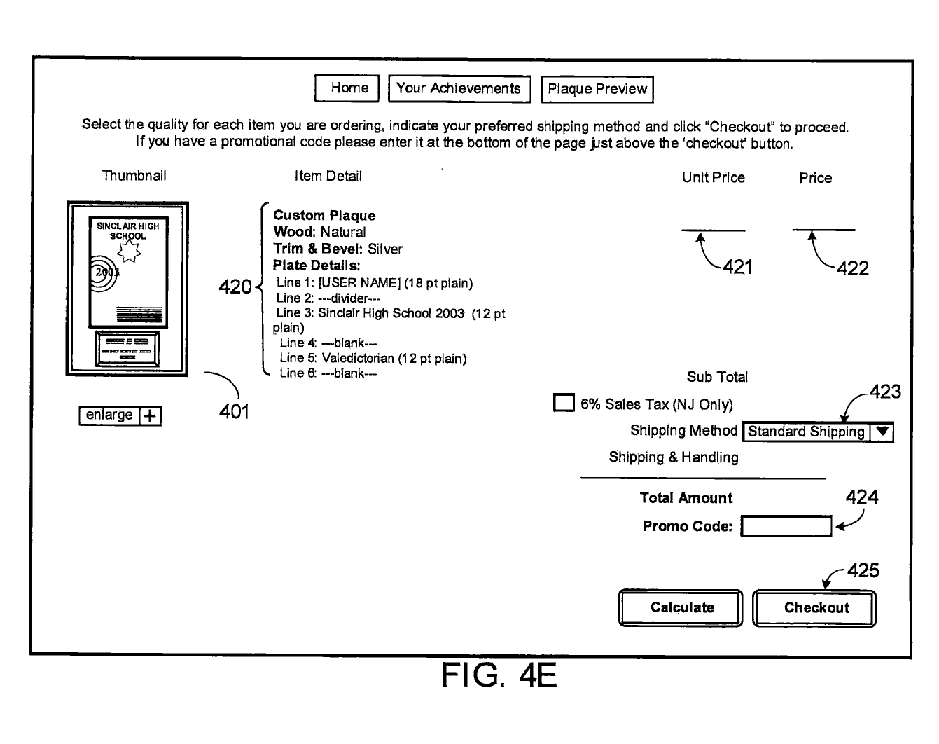

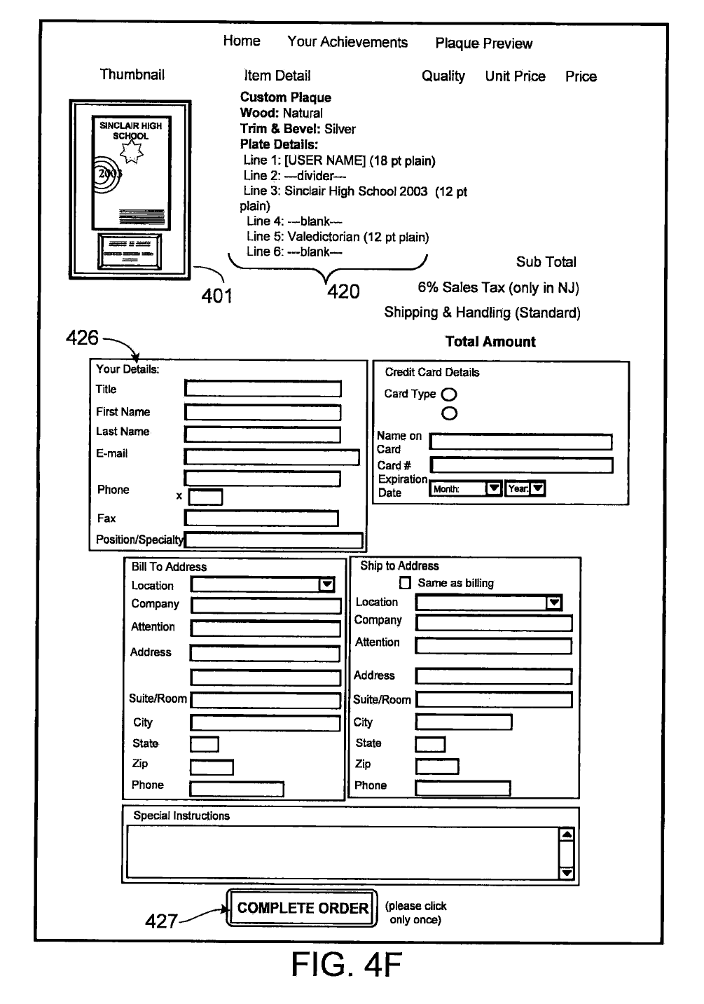

FIGS. 4A-4F are examples of screenshots of a website usable to implement the method of FIG. 3. Upon executing a web browser 405 pointed to an appropriate URL, the user is prompted with the login screen of FIG. 4A. After entering a valid activation code in the appropriate field, the user is given access to the next screen.

FIG. 4B illustrates a screenshot in which the user is presented with an initial preview 401 of plaque that incorporates a document 402 provided by the user. In this example, the document 402 is a high school diploma. The activation code (entered by the user in FIG. 4A) can be used to associate the document 402 with the user. Moreover, since kits (e.g., item 100 of FIG. 1) can be customized for the occasion, the activation code in this example is associated with a graduation kit, and congratulates the user accordingly. Although the user has not yet customized the plaque, he is given the option of adding it to his electronic shopping cart 410.

FIG. 4C depicts a screenshot of the point at which the user would perform, e.g., blocks 304 and 305 of FIG. 3. The user is provided options as to the trim color 404 and the plaque/frame/wood finish color 403. As the user makes choices in fields 403 or 404, the preview of the plaque automatically is updated in the preview area 401. In this example, the user has either (1) provided an electronic version of the document 402 or (2) provided a paper copy of the document 402 to the fulfillment agent in advance of accessing the website, such that the document has been scanned or otherwise made available for electronic preview. If the user wishes, he may click button 410 and place the plaque as it currently stands in the electronic shopping cart for purchase.

Alternatively, the user may proceed to the screen illustrated in FIG. 4D and provide customized text. The user specifies the particular text desired, as well its attributes (e.g., size and style) in area 406. After data is entered in area 406, the user may click button 408 and see a preview of the text plate in preview region 407. In the illustrated example, the user may enter up to six of text. The user can also choose to insert a dividing line. If the user is unhappy with the text, he can click the revert button 409 to start again.

FIG. 4E depicts a screenshot that is provided after a user clicks button 410 and adds the plaque to his electronic shopping cart. The user is provided with a “thumbnail” preview 401 of the plaque, as well as details 420 regarding the customization of the plaque. If the customization entailed extra-cost options, the cost will be indicated in fields 421 and 422. The user may also choose a shipping method via pull-down menu 423. Pull down menu 423 may indicate the added cost associated with certain shipping methods. Also, the user has the option of entering a promotional code in field 424 which may, e.g., entitle the user to a discount or upgraded shipping. If the user is satisfied, he presses the checkout button 425 to finalize the order.

FIG. 4F illustrates a screenshot for finalizing an order. Again, the user is provided with a thumbnail preview 401 of the plaque and the specifications 420. This provides the user with a final opportunity to confirm that he is satisfied with his customized plaque. If the user is satisfied, he completes the information in fields 426, and clicks button 427 to complete the order. Note that depending upon the activation code, the user may or may not be required to enter certain information in fields 426. For example, if a user did not exceed the allotted cost associated with the activation code, he may not need to enter any credit card details.

Various features may be implemented in hardware, software, or a combination of hardware and software. For example, some features may be implemented in computer programs executing on programmable computers. Each program may be implemented in a high level procedural or object-oriented programming language to communicate with a computer system or other machine. Furthermore, each such computer program may be stored on a storage medium such as read-only-memory (ROM) readable by a general or special purpose programmable computer or processor, for configuring and operating the computer to perform the functions described above.

A number of implementations of the invention have been described. Nevertheless, it will be understood that various modifications may be made without departing from the spirit and scope of the invention. For example, orders may be completed by using either an order form or a website. Accordingly, other implementations are within the scope of the claims.

1. A kit for a user to order a customized achievement recognition item from a vendor, the item being adapted to incorporate a document, the kit comprising:
an order form comprising one or more fields for allowing a user to specify features of the item, the order form also comprising a unique code; and
a container for shipping a document and the order form from the user to the vendor, the container adapted to protect the document.

2. The kit of claim 1 wherein the unique code identifies to the vendor any additional charges implicated by the user-specified features for the item.

3. The kit of claim 1 comprising a prepaid label for shipping the document and the order form.

4. The kit of claim 1 wherein the unique code is usable to give the user access to a website which allows the user to customize features of the item on-line.

5. A method for providing a user with a customized achievement recognition item ordered from a vendor, the plaque being adapted to incorporate a document, the method comprising:
providing a kit for purchase by the user, the kit comprising (1) an order form having a unique code and one or more fields for allowing a user to customize features of the item and (2) a container for shipping the document and the order form from the user to the vendor;
receiving the document and the order form from the user;
making the item according to the data provided in the fields;
incorporating the document into the item; and
shipping the item to the user.

6. The method of claim 5 wherein the unique code identifies to the vendor any additional charges implicated by the user's customization of the item.

7. The method of claim 5 wherein making the plaque comprises:
implementing an item color chosen by the user;
implementing an item size chosen by the user;
implementing a trim color chosen by the user;
implementing text chosen by the user; or
implementing a text plate trim color chosen by the user.

8. The method of claim 5 comprising providing the user with a preview of the item prior to shipping the item to the user.

9. The method of claim 8 wherein the preview is provided by mail, email or fax.

10. A method for providing a user with a customized achievement recognition item plaque ordered from a vendor, the item being adapted to preserve a document, the method comprising:
providing a kit for purchase by the user, the kit comprising (1) an order form having a unique code that grants access to a website and (2) a container for shipping a document from the user to the vendor;
receiving in a computerized network the unique code provided by the user and granting the user access to the website;
receiving data entered by the user via the website, the data relating to customizing the features of the item;
receiving the document from the user;
creating a preview of the item on the website;
making the item according to the data entered by the user via the website;
incorporating the document into the item; and
shipping the item to the user.

11. The method of claim 10 wherein the unique code identifies to the vendor any additional charges implicated by the user's specified features for the item.

12. The method of claim 10 wherein the document is in paper form, and receiving the document comprises receiving the document in the container by mail.

13. The method of claim 10 wherein the document is in electronic form.

14. The method of claim 13 wherein receiving the document comprises receiving an email from the user.

15. The method of claim 13 wherein receiving the document comprises receiving an electronic file uploaded by the user.

16. The method of claim 10 wherein the data that relates to customizing the features of the item comprises:
an item color chosen by the user;
an item size chosen by the user;
a trim color chosen by the user;
text chosen by the user; or
a text plate trim color chosen by the user.

17. The method of claim 10 wherein the preview is created substantially contemporaneously with receiving data relating to customizing the features of the item.

18. The method of claim 10 comprising receiving a selection from the user to identify a pre-existing document available on the website.
